(19) United States
(12) Patent Application Publication
(10) Pub. No.: US 2010/0201673 A1
(43) Pub. Date: Aug. 12, 2010

(54) LIGHT EMITTING DISPLAY DEVICE AND METHOD OF DRIVING THE SAME

(75) Inventors: Se-Ho KIM, Yongin-City (KR); Won-Kyu Kwak, Yongin-City (KR)

Correspondence Address: STEIN MCEWEN, LLP, 1400 EYE STREET, NW, SUITE 300, WASHINGTON, DC, 20005, US

(73) Assignee: Samsung Mobile Display Co., Ltd., Yongin-City (KR)

(21) Appl. No.: 12/690,969

(22) Filed: Jan. 21, 2010

(30) Foreign Application Priority Data
Feb. 6, 2009 (KR) 10-2009-0009861

(51) Int. Cl. G09G 5/00; G09G 3/30

(52) U.S. Cl. 345/211; 345/76

(57) ABSTRACT

A light emitting display device includes a plurality of pixel circuits, each including a compensation capacitor; a first switch element to apply a second power source voltage to the compensation capacitor while an initialization control signal is active; a second switch element to apply a data signal to the compensation capacitor while a scanning signal is active; a driving transistor driven by a first power source voltage to receive the data signal at a gate electrode thereof through the compensation capacitor, and generate a light emitting input signal according to the data signal; and a light emitting element to receive the light emitting input signal and emit light having a luminance according to an amplitude of the light emitting input signal. Second power source voltage supply lines to supply the second power source voltage to each of the plurality of pixel circuits have a net structure.

### CROSS-REFERENCE TO RELATED APPLICATIONS

This application claims the benefit of Korean Patent Application No. 10-2009-0009861 filed on Feb. 6, 2009, in the Korean Intellectual Property Office, the disclosure of which is incorporated herein by reference in its entirety.

### BACKGROUND OF THE INVENTION

1. Field of the Invention

Aspects of the invention relate to a light emitting display device, and more particularly, to an organic light emitting display device and a method of driving the same.

2. Description of the Related Art

An organic light emitting display device is a device that displays images when currents or voltages are applied to organic light emitting diodes (OLED) that emit light when fluorescent organic compounds are electrically excited.

An organic light emitting diode includes an anode layer, an organic thin film, and a cathode layer. The organic thin film has a multi-layered structure including an emitting material layer (EML), an electron transport layer (ETL), and a hole transport layer (HTL). These layers make electrons and holes have a good equilibrium state in order to enhance a light emitting efficiency. In addition, the organic thin film may include an electron injecting layer (EIL) and a hole injecting layer (HIL) separated from each other. The organic thin film emits light due to recombination of electrons and holes that reach the emitting material layer.

Generally, the organic light emitting display device includes a plurality of pixels arrayed in an N×M matrix pattern (N and M are natural numbers), and driving circuits for driving each of the pixels. A method of driving such an organic light emitting display device may be a passive matrix method or an active matrix method according to the type of the organic light emitting display device. In the case of the passive matrix method, anode stripe lines and cathode stripe lines are formed to intersect with one other, and are appropriately selected to drive pixels. In the case of the active matrix method, a data signal is applied to each pixel using a corresponding switching element, and the data signal is stored in a corresponding capacitor so that previously applied data can be maintained until a next data signal is applied. Thin film transistors may be used as the switching elements. The active driving method is classified into a voltage programming method and a current programming method according to the type of signals applied to the capacitors to maintain the voltages of the capacitors.

Driving transistors may be used to apply currents corresponding to data signals to the organic light emitting diodes of respective pixels. The driving transistor generates a current according to a data signal inputted to a gate electrode and inputs the current to the organic light emitting diode. The amplitude of the generated current is determined by a difference between a gate voltage according to the data signal and a source voltage according to a power source voltage.

Electrons and holes excited by the current applied from the driving transistor reach a junction in the organic light emitting diodes, and thus light is emitted due to recombination of the electrons and holes.

### SUMMARY OF THE INVENTION

Aspects of the invention relate to a light emitting device in which a power source voltage applied to compensate for a threshold voltage of a driving circuit at each pixel circuit is prevented from varying according to the locations of the pixels.

According to an aspect of the invention, a light emitting display device includes a plurality of pixel circuits each including a compensation capacitor; a first switch element to apply a second power source voltage to the compensation capacitor while an initialization control signal is active; a second switch element to apply a data signal to the compensation capacitor while a scanning signal is active; a driving transistor driven by a first power source voltage to receive the data signal at a gate electrode thereof through the compensation capacitor, and generate a light emitting input signal according to the data signal; and a light emitting element to receive the light emitting input signal and emit light having a luminance according to an amplitude of the light emitting input signal The light emitting device further includes second power source voltage supply lines having a net structure to supply the second power source voltage to each of the plurality of pixel circuits.

According to an aspect of the invention, the net structure of the second power source voltage supply lines includes a plurality of second power source voltage supply lines commonly connected to a voltage source of the second power source voltage and disposed in parallel in a first direction; and a plurality of second power source voltage supply lines disposed in parallel in a second direction and electrically connecting the plurality of second power source voltage supply lines disposed in parallel in the first direction to one other.

According to an aspect of the invention, the light emitting element is an organic light emitting diode (OLED).

According to an aspect of the invention, a light emitting display device includes a plurality of pixel circuits, the light emitting display device including a first power source voltage supply line to supply a first power source voltage as a driving voltage to a driving transistor of each of the pixel circuits that generates a light emitting input signal that is inputted to a light emitting element of each of the pixel circuits in response to a data signal for each of the pixel circuits; and a second power source voltage supply line to supply a second power source voltage to a compensation capacitor of each of the pixel circuits connected to a gate electrode of the driving transistor of each of the pixel circuits to compensate the data signal for a threshold voltage of the driving transistor. The second power source voltage supply line is part of a net structure of second power source voltage supply lines.

According to an aspect of the invention, a light emitting display device includes a plurality of pixel circuits; a first power source voltage supply line to supply a first power source voltage to each of the plurality of pixel circuits; and a second power source voltage supply line to supply a second power source voltage to each of the plurality of pixel circuits. Each of the plurality of pixel circuits includes a light emitting portion to emit light in response to a light emitting input signal; a data input portion to receive a data signal in response to a scanning signal; a driving portion driven by the first power source voltage to generate the light emitting input signal according to a compensated data signal, and output the light emitting input signal to the light emitting portion; and a threshold voltage compensation portion to receive the data signal received by the data input portion, receive the second power source voltage, and compensate the data signal received by the data input portion for a threshold voltage of the driving portion using the second power source voltage, and output the compensated data signal to the driving portion. The second power source voltage supply lines have a net structure.

According to an aspect of the invention, a method of driving a light emitting display device including a plurality of pixel circuits is provided. Each of the pixel circuits includes a light emitting element; a driving transistor driven by a first power source voltage to output a light emitting input signal to the light emitting element according to a data signal; and a compensation capacitor having one end connected to a second power source voltage via a switch element and another end connected to a gate electrode of the driving transistor to compensate the data signal for a threshold voltage of the driving transistor. The method includes applying the second power source voltage to the compensation capacitor through the switch element to charge the compensation capacitor to the threshold voltage of the driving transistor; inputting the data signal to the gate electrode of the driving transistor through the compensation capacitor so that the compensation capacitor compensates the data for the threshold voltage of the driving transistor; and inputting the light emitting input signal generated by the driving transistor to the light emitting element. The second power source voltage supply line to supply the second power source voltage to each of the plurality of pixel circuits is part of a net structure of second power source voltage supply lines.

According to an aspect of the invention, the method further includes connecting the driving transistor in a diode-connected configuration while applying the second power voltage to the compensation capacitor to charge the compensation capacitor.

Additional aspects and/or advantages of the invention will be set forth in part in the description that follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of embodiments of the invention, taken in conjunction with the accompanying drawings, of which:

FIG. 1 is a diagram of a pixel circuit of a light emitting display device;

FIG. 2 is a diagram for describing problems that occur when a panel of a light emitting display device becomes larger;

FIG. 3 is a diagram of a light emitting display device according to an aspect of the invention;

FIG. 4 is a diagram of a structure of a second power source voltage supply line according to an aspect of the invention;

FIG. 5 is a diagram of a structure of a pixel circuit of a light emitting display device according an aspect of the invention;

FIG. 6 is a diagram of a structure of a light emitting display device according to an aspect of the invention using the pixel circuit shown in FIG. 5;

FIG. 7 is a diagram of a structure of a pixel circuit of a light emitting display device according to an aspect of the invention;

FIG. 8 is a diagram of a structure of a light emitting display device according to an aspect of the invention using the pixel circuit shown in FIG. 7; and

FIG. 9 is a flowchart of a method of driving a light emitting display device according to an aspect of the invention.

### DETAILED DESCRIPTION OF THE INVENTION

Reference will now be made to embodiments of the invention, examples of which are shown in the accompanying drawings, wherein like reference numerals refer to like elements throughout. The embodiments are described below to explain the invention by referring to the figures, and detailed descriptions of features well known to one of ordinary skill in the art may be omitted.

The scope of the invention is not to be limited by the specification and the drawings, but is defined the claims and their equivalents. The terms used in the specification are to be interpreted as they would be understood by one of ordinary skill in the art to which the invention pertains.

In the following description, when one element is described as being “connected to” or “coupled to” another element, it is understood that the one element may be directly connected to or coupled to the other element without any intervening element therebetween, or may be indirectly connected to or coupled to the other element through one or more intervening elements.

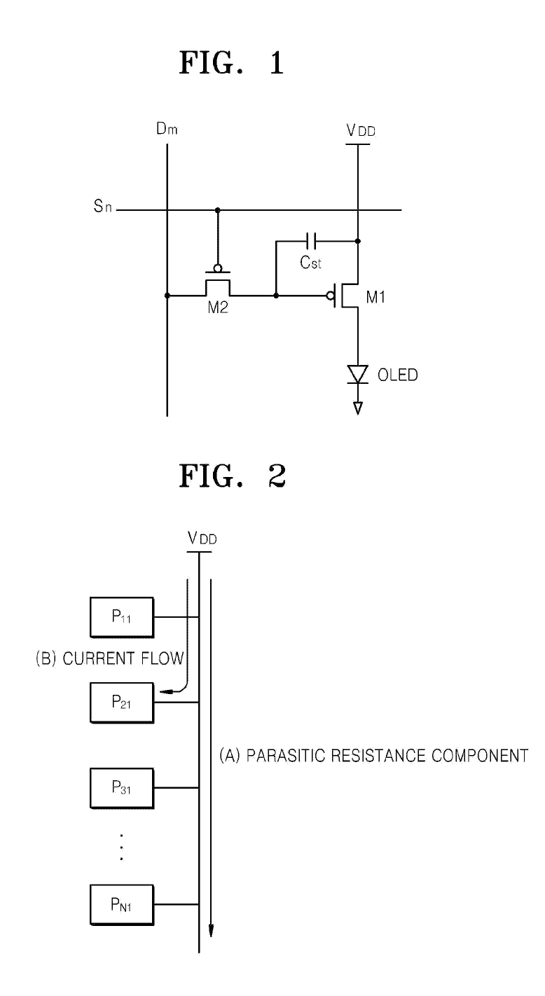

FIG. 1 is a diagram of a pixel circuit of a light emitting display device. The pixel circuit of the light emitting display device includes a light emitting element, such as an organic light emitting diode (OLED), a driving transistor M1, a scanning transistor M2, and a storage capacitor Cst. The driving transistor M1 generates a current in response to a data signal Dm inputted through the scanning transistor M2, and supplies the current to the light emitting element, such as the OLED. The data signal Dm is applied to the driving transistor M1 in response to a scanning signal Sn only during an interval. In addition, while the data signal Dm is being applied to the driving transistor for the scanning time interval, the data signal Dm is stored in the storage capacitor Cst, and a voltage corresponding to the data signal Dm continues to be applied to the driving transistor M1 even after the scanning time interval has elapsed. When the current generated by the driving transistor M1 is applied to the OLED, the OLED emits light having a luminance corresponding to an amplitude of the current applied to the OLED.

The amplitude of the current applied to the OLED by the driving transistor M1 is expressed by the following Equation 1.

$${I}_{OLED} = \frac{β}{2} {( {V}_{gs} - {V}_{th} )}^{2} = \frac{β}{2} {( VDD - {V}_{data} - \vert {V}_{th} \vert )}^{2} \qquad ( 1 )$$

where I_{OLED} is a current flowing through the OLED, Vgs is a voltage between a gate electrode and a source electrode of the driving transistor M1, Vth is a threshold voltage of the driving transistor M1, Vdata is a voltage of a data signal Dmapplied to the gate electrode of the driving transistor M1 via the scanning transistor M2, and β is a constant. As expressed in Equation 1, a current supplied to the OLED depends on the voltage Vdata of the data signal Dm, a power source voltage VDD, and the threshold voltage Vth. However, when a panel of a light emitting display device becomes larger, a problem occurs wherein the amplitudes of the power source voltage VDD (hereinafter referred to as a first power source voltage) and the threshold voltage Vth vary with the positions of the pixels.

FIG. 2 is a diagram for describing this problem that occurs when a panel of a light emitting display device becomes larger. In general, the panel includes a plurality of pixel circuits arrayed in an N×M matrix pattern, and the data signal Dm, the scanning signal Sn, and the first power source voltage VDD are applied to each of the pixel circuits. The first power source voltage VDD may be commonly supplied to all of the pixel circuits.

However, referring to FIG. 2, when the first power source voltage VDD is supplied to each of the pixel circuits, a voltage drop may occur. In general, a parasitic resistance component exists in wiring for supplying a power source voltage, and when the first power source voltage VDD is supplied through such wiring, a voltage drop occurs due to the parasitic resistance component. Therefore, as the length of the wiring between each of the pixel circuits and a voltage source of the first power source voltage VDD becomes longer, the level of the first power source voltage VDD supplied to the corresponding pixel circuit becomes lower (see (A) in FIG. 2).

In addition, when the first power source voltage VDD is applied to the driving transistor M1 of each of the pixel circuits as a driving voltage, a current flows from a supply line of the first power source voltage VDD to the driving transistor M1. Due to the current flow to each of the pixel circuits, as the position of the pixel circuit becomes more distant from the supply point of the first power source voltage VDD, the voltage level of the first power source voltage VDD supplied to the corresponding pixel circuit becomes lower (see (B) in FIG. 2). Thus, a problem of long-range uniformity (LR) in which the first power source voltage VDD in Equation 1 varies with the positions of the pixels occurs.

In addition, a problem of short-range uniformity (SR) occurs since the amount of current supplied to the OLED varies, as described previously, due to a deviation of the threshold voltage Vth of a thin film transistor (TFT) that occurs when the manufacturing process is not uniformly performed for all of the TFTs. Such a problem becomes more serious as the panel becomes larger. In order to compensate for a lack of uniformity of the threshold voltage Vth of each of the pixel circuits, the pixel circuit further includes a compensation capacitor (not shown in FIG. 1) connected to the gate electrode of the driving transistor, and thus the lack of uniformity of the threshold voltage Vth can be compensated for by applying a power source voltage to the compensation capacitor. A second power source voltage Vsus may be provided as the power source voltage. However, for the reasons discussed above in connection with the first power source voltage VDD, the second power source voltage Vsus is also subject to a voltage drop (see (A) in FIG. 2) due to a parasitic resistance component of a supply line of the second power source voltage Vsus, and a voltage drop (see (B) in FIG. 2) due to a current flowing to each of the pixel circuits. Accordingly, the voltage level of the second power source voltage Vsus also varies with the positions of the pixels.

The supply line of the second power source voltage Vsus typically has a supply capacity that is smaller than the supply capacity of the supply line of the first power source voltage VDD. In such a case, the variation of the second power source voltage Vsus is higher than the variation of the first power source voltage VDD, and increases even more than the variation of the first power source voltage VDD increases as the panel becomes larger.

To solve such a problem, according to an aspect of the invention, the supply line of the second power source voltage Vsus for supplying the second power source voltage Vsus to each of the plurality of the pixel circuits is formed to have a net structure.

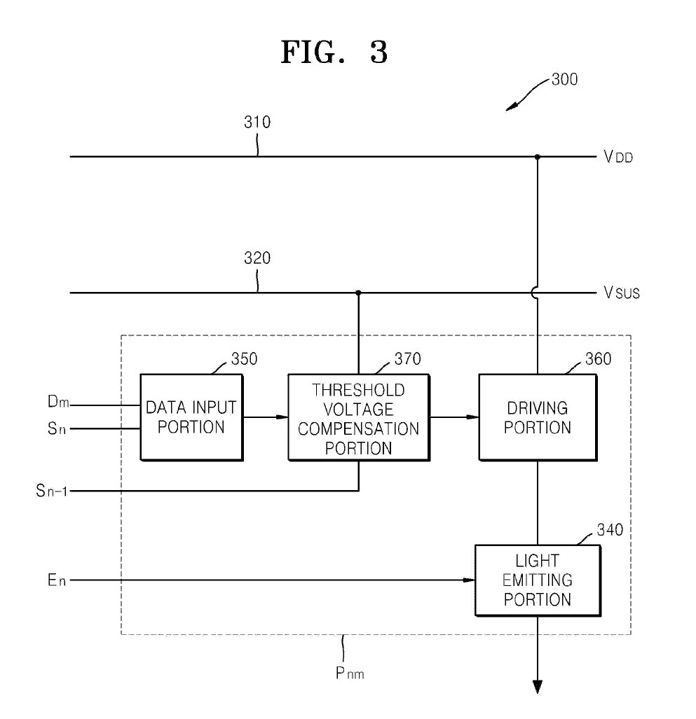

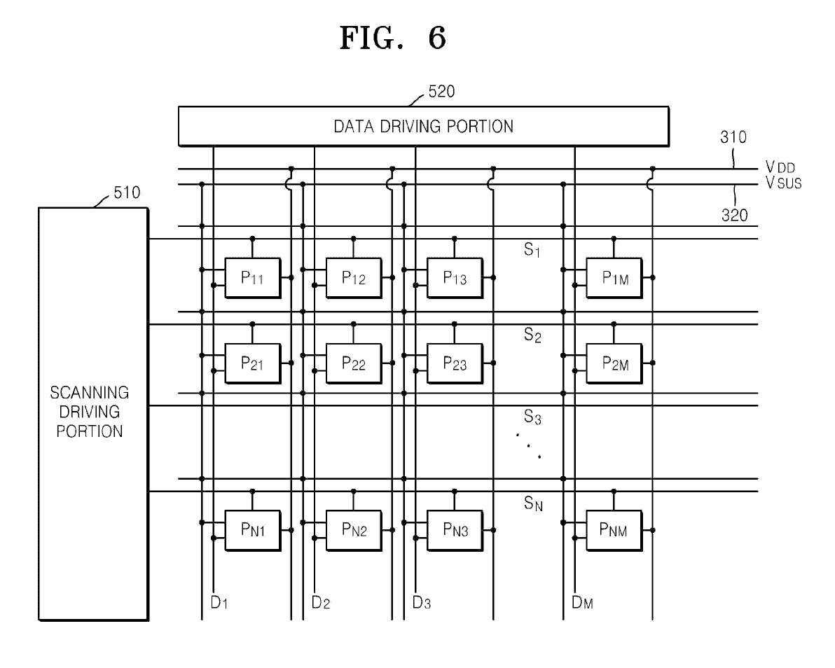

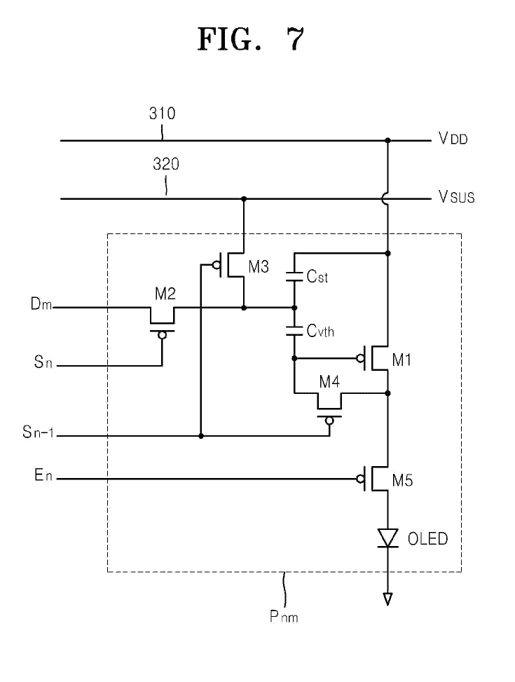

FIG. 3 is a diagram showing a light emitting display device 300 according to an aspect of the invention. The light emitting display device 300 includes a plurality of pixel circuits Pnm, a first power source voltage supply line 310, and a second power source voltage supply line 320. The plurality of pixel circuits Pnm may be arrayed in a N×M matrix pattern as shown in FIG. 6.

The first power source voltage supply line 310 and the second power source voltage supply line 320 are connected to each of the pixel circuits Pnm to respectively apply the first power source voltage VDD and the second power source voltage Vsus thereto. To accomplish this, the first power source voltage supply line 310 may be electrically connected to a first voltage source (not shown) supplying the first power source voltage VDD, and the second power source voltage supply line 320 may be electrically connected to a second voltage source (not shown) supplying the second power source voltage Vsus.

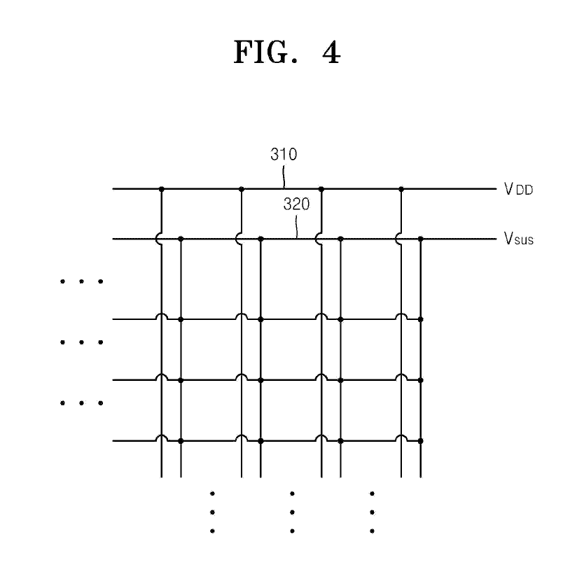

According to an aspect of the invention, the second power source voltage supply line 320 has a net structure as shown in FIG. 4. In this net structure, a plurality of second power source voltage supply lines 320 disposed in parallel in a first direction are electrically connected to one other by a plurality of second power source voltage supply lines 320 disposed in parallel in a second direction. By using this net structure, even though a voltage drop occurs in one of the second power source voltage supply lines 320, since the voltage drop can be compensated for by adjacent ones of the second power source voltage supply lines 320, the voltage level of the second power source voltage supply lines 320 can be maintained substantially constant over the entire area of the panel of the light emitting display device.

Referring again to FIG. 3, each of the plurality of pixel circuits Pnm includes a light emitting portion 340, a data input portion 350, a driving portion 360, and a threshold voltage compensation portion 370.

The light emitting portion 340 receives a light emitting input signal, and emits light having a luminance according to the amplitude of the light emitting input signal. The light emitting portion 340 may include any type of light emitting element that can emit light in response to an electrical input signal, and the light emitting element may be, for example, an OLED. In addition, the light emitting input signal may be a current-type light emitting input signal or a voltage-type light emitting input signal.

Further, the light emitting portion 340 may be constructed to receive a light emitting input signal only during an interval in response to a light emitting control signal En. In such a construction, the light emitting input signal may be inputted to the light emitting element through a switch element that is switched on or off in response to the light emitting control signal En.

The data input portion 350 receives the data signal Dm during an interval in response to the scanning signal Sn, and stores the data signal Dm inputted during the interval. To accomplish this, the data input portion 350 may include a switch element that is switched on or off in response to the scanning signal Sn. In addition, the data input portion 350 may include a storage capacitor to store the inputted data signal Dm.

The threshold voltage compensation portion 370 stores a voltage corresponding to a threshold voltage of the driving portion 360 to compensate for the threshold voltage of the driving portion 360 before the data signal Dm is inputted. When the data signal Dm is inputted to the driving portion 360, the threshold voltage compensation portion 370 compensates for the voltage level corresponding to the threshold voltage. To accomplish this, the threshold voltage compensation portion 370 may include a compensation capacitor to store the voltage corresponding to the threshold voltage. In addition, the threshold voltage compensation portion 370 may include a switch element for applying the second power source voltage Vsus to the compensation capacitor in response to an initialization control signal Sn−1 that is activated during an interval before the data signal Dm is inputted. The initialization control signal Sn−1 may be a scanning signal Sn−1 applied to another pixel circuit that is scanned during a preceding scanning interval, in which case the second power source voltage Vsus will be applied to the compensation capacitor during the preceding scanning interval. Further, the threshold voltage compensation portion 370 may include a switch element to connect the driving transistor of the driving portion 360 in a diode-connected configuration in response to the initialization control signal Sn−1.

The driving portion 360 receives the data signal Dm inputted through the threshold voltage compensation portion 370, generates the light emitting input signal corresponding to the amplitude of the data signal Dm, and outputs the light emitting input signal to the light emitting portion 340. To accomplish this, the driving portion 360 may include a driving transistor. The driving transistor may receive the data signal Dm via a gate electrode included therein in order to generate the light emitting input signal. The first power source voltage VDD may be applied to a source electrode of the driving transistor through the first power source voltage supply line 310 to serve as a driving voltage of the driving transistor.

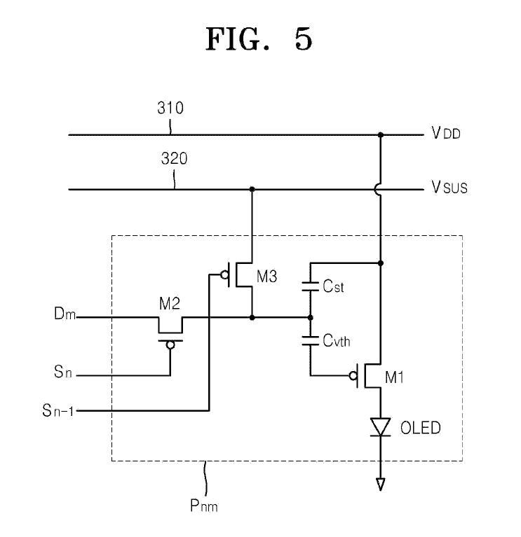

FIG. 5 is a diagram showing a structure of a pixel circuit of a light emitting display device, according an aspect of the invention. This pixel circuit includes an OLED, a driving transistor M1, a first switch element M3, a compensation capacitor Cvth, a second switch element M2, and a storage capacitor Cst. The first power source voltage supply line 310 for supplying the first power source voltage VDD is connected to the driving voltage electrode of the driving transistor M1, and the second power source voltage supply line 320 for supplying the second power source voltage Vsus is connected to one end of the first switch element M3.

Before the data signal Dm is inputted by the activation of the scanning signal Sn, a voltage for compensating for the threshold voltage of the driving transistor M1 is stored in the compensation capacitor Cvth. To accomplish this, the initialization control signal Sn−1 is activated during an interval before the scanning signal Sn is activated, and the second power source voltage Vsus is applied to the compensation capacitor Cvth through the first switch element M3 in response to the activation of the initialization control signal Sn−1. The compensation capacitor Cvth is charged by the second power source voltage Vsus up to the voltage level corresponding to the threshold voltage of the driving transistor M1.

After the activation interval of the initialization control signal Sn−1 is completed, the scanning signal Sn is activated and the data signal Dm is inputted to the storage capacitor Cst through the second switch element M2. The data signal Dm is applied to the storage capacitor Cst during the activation interval of the scanning signal Sn, and the storage capacitor Cst stores the data signal Dm. The data signal Dm may be stored in the storage capacitor Cst according to a voltage programming method or a current programming method.

The data signal Dm stored in the storage capacitor Cst is inputted to the gate electrode of the driving transistor M1 through the compensation capacitor Cvth. Since the threshold voltage of the driving transistor M1 is compensated for by the compensation capacitor Cvth, the light emitting input signal generated by the driving transistor M1 is independent of the threshold voltage of the driving transistor M1.

The light emitting input signal is inputted to the OLED, and the OLED generates light having a luminance corresponding to the amplitude of the light emitting input signal. The light emitting input signal may be a current-type light emitting input signal, or a voltage-type light emitting input signal.

Although the first switch element M3 and the second switch element M2 are shown in FIG. 5 as being p-type MOSFETs, any type of element capable of performing a switch function in response to a control signal may be used.

The second switch element M2 and the storage capacitor Cst correspond to the data input portion 350 in FIG. 3, the first switch element M3 and the compensation capacitor Cvth correspond to the threshold voltage compensation portion 370 in FIG. 3, the driving transistor M1 corresponds to the driving portion 360 in FIG. 3, and the OLED corresponds to the light emitting portion 340 in FIG. 3.

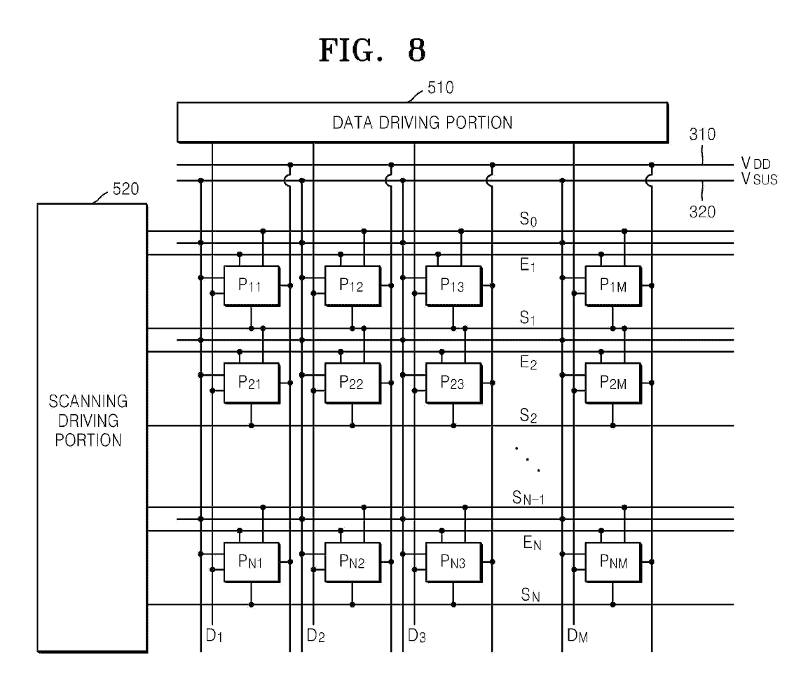

FIG. 6 is a diagram of a structure of a light emitting display device according to an aspect of the invention using the pixel circuit Pnm shown in FIG. 5. A plurality of the pixel circuits Pnm are arrayed in an N×M matrix pattern. First power source voltage supply lines 310 for supplying the first power source voltage and second power source voltage supply lines 320 for supplying the second power source voltage are connected to the pixel circuits Pnm. The light emitting display device includes a scanning driving portion 510 for supplying scanning signals Sn to the plurality of pixel circuits Pnm, and a data driving portion 520 for supplying data signals Dm to the plurality of pixel circuits Pnm. According to an aspect of the invention, the scanning signals Sn may be commonly applied to pixel circuits Pnm in the same row n. In addition, although not shown in FIG. 6, according to an aspect of the invention, the initialization control signal Sn−1 for a current row n may be a scanning signal Sn−1 of a previous row n−1 that was activated before the scanning signal Sn for the current row n is activated (see FIG. 8).

As shown in FIG. 6, the second power source voltage supply lines 320 have a net structure. In this net structure, a plurality of supply lines 320 disposed in parallel in a first direction are electrically connected to one other by a plurality of second power source voltage supply lines 320 disposed in parallel in a second direction.

FIG. 7 is a diagram of a structure of a pixel circuit of a light emitting display device, according to an aspect of the invention. This pixel circuit includes an OLED, a fourth switch element M5, a driving transistor M1, a first switch element M3, a third switch element M4, a compensation capacitor Cvth, a second switch element M2, and a storage capacitor Cst. The first power source voltage supply line 310 for supplying the first power source voltage VDD is connected to the driving voltage electrode of the driving transistor M1, and the second power source voltage supply line 320 for supplying the second power source voltage Vsus is connected to one end of the first switch element M1.

When an initialization control signal Sn−1 is activated, the first switch element M3 and the third switch element M4 are turned on. When the third switch element M4 is turned on, the driving transistor M1 is connected in diode-connected configuration, and a voltage Vgs between the gate electrode and the source electrode of the driving transistor M1 becomes the threshold voltage Vth of the driving transistor M1. Since the source voltage of the driving transistor M1 is the first power source voltage VDD, a voltage applied to the gate electrode of the driving transistor M1, that is, a voltage applied to one end of the compensation capacitor Cvth, becomes VDD+Vth. In addition, when the first switch element M3 is turned on, the second power source voltage Vsus is applied to the other end of the compensation capacitor Cvth. Therefore, a voltage across the compensation capacitor Cvth is expressed by the following Equation 2:

V_{Cvth}=V_{Cvth1}−V_{Cvth2}=(VDD+Vth)−Vsus

where V_{Cvth} is the voltage across the compensation capacitor Cth, V_{Cvth1} is a voltage applied to one end of the compensation capacitor Cvth, and V_{Cvth2} is a voltage applied to the other end of the compensation capacitor Cvth.

Next, the initialization control signal Sn−1 is inactivated, and the scanning signal Sn is activated. The operations of the second switch element M2 and the storage capacitor Cst in response to the activation of the scanning signal Sn are the same as those described with reference to FIG. 5.

After the data signal Dm is stored in the storage capacitor Cst, a voltage Vgs between the gate electrode and the source electrode of the driving transistor M1 is expressed by the following Equation 3:

V_{gs}=(Vdata+(VDD+Vth−Vsus))−VDD=Vdata+Vth−Vsus (3)

Next, the light emitting control signal En is activated, which turns on the fourth switch element M5. This causes a light emitting control signal generated by the driving transistor M1 in response to the voltage Vgs between the gate electrode and the source electrode of the driving transistor M1 to be applied to the OLED. A current I_{OLED} flowing through the OLED is expressed by the following Equation 4:

$$\begin{matrix}{I}_{OLED} = \frac{β}{2} {( {V}_{gs} - {V}_{th} )}^{2} \\ = \frac{β}{2} {( ( Vdata + Vth - Vsus ) - Vth )}^{2} \\ = \frac{β}{2} {( Vdata - Vsus )}^{2}\end{matrix} \qquad ( 4 )$$

That is, a light emitting input signal according to Equation 4 is inputted to the OLED, and the OLED emits light having a luminance according to the amplitude of the current I_{OLED}, which is the light emitting input signal. The amplitude of the light emitting input signal depends on the amplitude of the data signal Vdata and the amplitude of the second power source voltage Vsus as expressed in Equation 4. Therefore, if the second power source voltage Vsus applied to each of the pixel circuits Pnm varies according to the positions of the pixel circuits Pnm because of a voltage drop (due to a parasitic resistance component of the second power source voltage supply line 320 (see (A) in FIG. 2), or a voltage drop due to current flowing to the pixel circuits Pnm (see (B) in FIG. 2), a distortion of a displayed image occurs.

Therefore, according to an aspect of the invention, the second power source voltage supply lines 320 are connected to one other in a net structure to substantially eliminate the variation of the second power source voltage Vsus according to the positions of the pixel circuits. This net structure enables the second power source voltage Vsus to be supplied to the plurality of pixel circuits Pnm with a substantially constant amplitude, thereby reducing the distortion of the displayed image. In addition, crosstalk between the second power source voltage supply lines 320 due to an instantaneous voltage drop in the second power source voltage Vsus can be prevented.

FIG. 8 is a diagram of a structure of a light emitting display device according to an aspect of the invention using the pixel circuit Pnm shown in FIG. 7. A plurality of the pixel circuits Pnm are arrayed in a N×M matrix pattern. The first power source voltage supply line 310 for supplying the first power source voltage VDD and the second power source voltage supply line 320 for supplying the second power source voltage Vsus are connected to each of the pixel circuits Pnm. The second power source voltage supply lines 320 are arranged in a net structure. The light emitting display device further includes a scanning driving portion 510 for supplying a scanning signal Sn and a light emitting control signal En to the plurality of pixel circuits Pnm, and a data driving portion 520 for supplying a data signal Dm to the plurality of pixel circuits Pnm. According to an aspect of the invention, the scanning signal Sn may be commonly applied to pixel circuits Pnm in the same row n. In addition, according to an aspect of the invention, the initialization control signal Sn−1 for a current row n may be a scanning signal Sn−1 of a previous row n−1 that was activated before the scanning signal Sn for the current row n is activated.

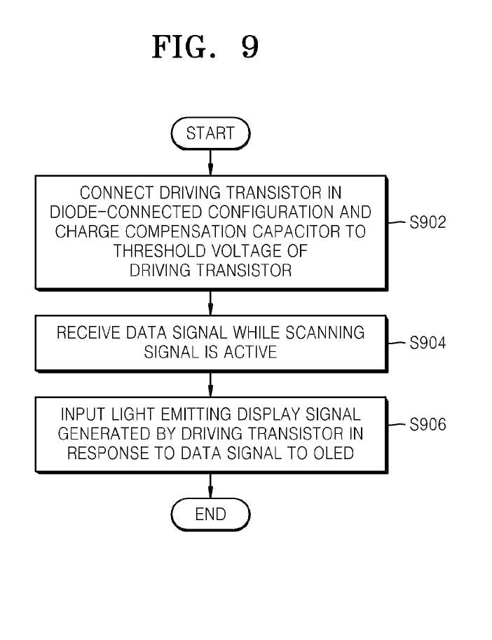

FIG. 9 is a flowchart of a method of driving the light emitting display device according to an aspect of the invention shown in FIG. 8. In this light emitting display device, the data signal Dm may be inputted to each pixel circuit on a frame-by-frame basis by sequentially activating the scanning signals Sn during a period of one frame, and simultaneously inputting the data signals Dm to all of the pixel circuits Pmn in the same row n for which the scanning signal Sn is currently activated, thereby sequentially inputting the data signals Dm to the pixel circuits Pnm in the same column m as the scanning signals Sn are sequentially activated. The initialization control signal Sn−1 and the light emitting control signal En may be commonly applied to the pixel circuits Pnm in the same row n, and may be sequentially activated for each of the rows n.

When the initialization control signal Sn−1 is activated, the driving transistor M1 is connected in a diode-connected configuration, and the second power source voltage Vsus is applied to the compensation capacitor Cvth through the first switch element (S902). The compensation capacitor Cvth is charged to the level of the threshold voltage Vth of the driving transistor M1 while the initialization control signal Sn−1 is active. The second power source voltage supply line 320 for supplying the second power source voltage Vsus to each of the plurality of pixel circuits Pnm has a net structure.

After the initialization control signal Sn−1 becomes inactive, the scanning signal Sn is activated. While the scanning signal Sn is active, the data signal Dm is inputted to the storage capacitor Cst and is stored in the storage capacitor Cst (S904). The data signal Dm stored in the storage capacitor Cst is inputted to the gate electrode of the driving transistor M1 through the compensation capacitor Cvth, and the driving transistor M1 generates a light emitting display signal in response to the inputted data signal Dm. The driving transistor M1 is driven by the first power source voltage VDD.

Subsequently, the light emitting control signal En is activated, and the light emitting display signal is inputted to the OLED while the light emitting control signal En is active (S906). The OLED emits light having a luminance according to the light emitting display signal.

A light emitting display device and a method of driving a light emitting display device according to aspects of the invention are effective in compensating for a voltage drop in a second power source voltage applied to each pixel circuit due to an increase in the size of the panel of the light emitting display device. In addition, since the voltage drop of the second power source voltage is compensated for, a distortion of a displayed image of the light emitting display device due to an increase in the size of the panel can be reduced. Further, crosstalk between a plurality of power source voltage supply lines for supplying the second power source to the pixel circuits can be prevented.

Although several embodiments of the invention have been shown and described, it would be appreciated by those of ordinary skill in the art that changes may be made in these embodiments without departing from the principles and spirit of the invention, the scope of which is defined in the claims and their equivalents.

What is claimed is:

1. A light emitting display device comprising a plurality of pixel circuits, each of the plurality of pixel circuits comprising:
a compensation capacitor;
a first switch element to apply a second power source voltage to the compensation capacitor while an initialization control signal is active;
a second switch element to apply a data signal to the compensation capacitor while a scanning signal is active;
a driving transistor driven by a first power source voltage to receive the data signal at a gate electrode thereof through the compensation capacitor, and generate a light emitting input signal according to the data signal; and
a light emitting element to receive the light emitting input signal and emit light having a luminance according to an amplitude of the light emitting input signal;
wherein the light emitting display device further comprises second power source voltage supply lines having a net structure to supply the second power source voltage to each of the plurality of pixel circuits.

2. The light emitting display device of claim 1, wherein the second power source voltage supply lines having the net structure comprise:
a plurality of second power source voltage supply lines commonly connected to a voltage source of the second power source voltage and disposed in parallel in a first direction; and
a plurality of second power source voltage supply lines disposed in parallel in a second direction and electrically connecting the plurality of second power source voltage supply lines disposed in parallel in the first direction to one other.

3. The light emitting display device of claim 1, wherein each of the plurality of pixel circuits further comprises a storage capacitor to receive and store the data signal, the storage capacitor being coupled to the gate electrode of the driving transistor via the compensation capacitor.

4. The light emitting display device of claim 1, wherein each of the plurality of pixel circuits further comprises a third switch element to connect the driving transistor in a diode-connected configuration in response to the initialization control signal.

5. The light emitting display device of claim 1, wherein the initialization control signal of each of the plurality of pixel circuits is a scanning signal applied to another one of the plurality of pixel circuits in a previous scanning period.

6. The light emitting display device of claim 1, wherein each of the plurality of pixel circuits further comprises a fourth switch element to apply the light emitting input signal to the light emitting element while a light emitting control signal is active.

7. The light emitting display device of claim 1, wherein the light emitting element is an organic light emitting diode (OLED).

8. A light emitting display device comprising a plurality of pixel circuits, the light emitting display device comprising:
a first power source voltage supply line to supply a first power source voltage as a driving voltage to a driving transistor of each of the pixel circuits that generates a light emitting input signal that is inputted to a light emitting element of each of the pixel circuits in response to a data signal for each of the pixel circuits; and
a second power source voltage supply line to supply a second power source voltage to a compensation capacitor of each of the pixel circuits connected to a gate electrode of the driving transistor of each of the pixel circuits to compensate the data signal for a threshold voltage of the driving transistor;
wherein the second power source voltage supply line is part of a net structure of second power source voltage supply lines.

9. The light emitting display device of claim 8, wherein the net structure of the second power source voltage supply lines comprises:
a plurality of second power source voltage supply lines commonly connected to a voltage source of the second power source voltage and disposed in parallel in a first direction; and
a plurality of second power source voltage supply lines disposed in parallel in a second direction and electrically connecting the plurality of second power source voltage supply lines disposed in parallel in the first direction to one other.

10. The light emitting display device of claim 8, wherein each of the pixel circuits comprises:
a compensation capacitor;
a first switch element to apply the second power source voltage to the compensation capacitor while an initialization control signal is active;
a second switch element to apply a data signal to the compensation capacitor while a scanning signal is active;
a driving transistor driven by the first power source voltage to receive the data signal at a gate electrode thereof through the compensation capacitor, and generate a light emitting input signal according to the data signal; and
a light emitting element to receive the light emitting signal and emit light having a luminance according to the light emitting input signal.

11. The light emitting display device of claim 10, further comprising:
a scanning driving portion to output the scanning signal and the initialization control signal; and
a data driving portion to output the data signal.

12. The light emitting display device of claim 10, wherein the light emitting element is an organic light emitting diode (OLED).

13. A light emitting display device comprising:
a plurality of pixel circuits;
a first power source voltage supply line to supply a first power source voltage to each of the plurality of pixel circuits; and
a second power source voltage supply line to supply a second power source voltage to each of the plurality of pixel circuits;
wherein each of the plurality of pixel circuits comprises:
a light emitting portion to emit light in response to a light emitting input signal;
a data input portion to receive a data signal in response to a scanning signal;
a driving portion driven by the first power source voltage to generate the light emitting input signal according to a compensated data signal, and output the light emitting input signal to the light emitting portion; and
a threshold voltage compensation portion to receive the data signal received by the data input portion, receive the second power source voltage, compensate the data signal received by the data input portion for a threshold voltage of the driving portion using the second power source voltage, and output the compensated data signal to the driving portion; and
wherein the second power source voltage supply lines have a net structure.

14. The light emitting display device of claim 13, wherein the net structure of the second power source voltage supply lines comprises:
a plurality of second power source voltage supply lines commonly connected to a voltage source of the second power source voltage and disposed in parallel in a first direction; and
a plurality of second power source voltage supply lines disposed in parallel in a second direction and electrically connecting the plurality of second power source voltage supply lines disposed in parallel in the first direction to one other.

15. The light emitting display device of claim 13, further comprising:
a scanning driving portion to output the scanning signal; and
a data driving portion to output the data signal.

16. The light emitting display device of claim 13, wherein:
the threshold voltage compensation portion comprises a compensation capacitor having one end connected to driving portion, applies the second power source voltage to another end of the compensation capacitor in response to an initialization control signal activated before the scanning signal is activated to charge the compensation capacitor to the threshold voltage of the driving portion, and compensates the data signal received by the data input portion for the threshold voltage of the driving portion and outs the compensated data signal to the driving portion by applying the data signal received by the data input portion to the driving portion through the compensation capacitor charged to the threshold voltage of the driving portion; and
the scanning driving portion further outputs the initialization control signal.

17. The light emitting display device of claim 13, wherein the light emitting portion comprises an organic light emitting diode (OLED).

18. A method of driving a light emitting display device comprising a plurality of pixel circuits, each of the pixel circuits comprising a light emitting element; a driving transistor driven by a first power source voltage to output a light emitting input signal to the light emitting element according to a data signal; and a compensation capacitor having one end connected to a second power source voltage via a switch element and another end connected to a gate electrode of the driving transistor to compensate the data signal for a threshold voltage of the driving transistor; the method comprising:
applying the second power source voltage to the compensation capacitor through the switch element to charge the compensation capacitor to the threshold voltage of the driving transistor;
inputting the data signal to the gate electrode of the driving transistor through the compensation capacitor so that the compensation capacitor compensates the data signal for the threshold voltage of the driving transistor; and
inputting the light emitting input signal generated by the driving transistor to the light emitting element;
wherein a second power source voltage supply line to supply the second power source voltage to each of the plurality of pixel circuits is part of a net structure of second power source voltage supply lines.

19. The method of claim 18, wherein the net structure of the second power source voltage supply lines comprises:
a plurality of second power source voltage supply lines commonly connected to a voltage source of the second power source voltage and disposed in parallel in a first direction; and
a plurality of second power source voltage supply lines disposed in parallel in a second direction and electrically connecting the plurality of second power source voltage supply lines disposed in parallel in the first direction to one other.

20. The method of claim 18, further comprising connecting the driving transistor in a diode-connected configuration while applying the second power source voltage to the compensation capacitor to charge the compensation capacitor.

21. The method of claim 18, wherein the light emitting element is an organic light emitting diode (OLED).
